(19) United States
(12) Patent Application Publication
(10) Pub. No.: US 2026/0239321 A1
(43) Pub. Date: Aug. 13, 2026

(54) METHODS AND APPARATUS FOR UPLINK (UL) TRANSMISSION DYNAMIC SWITCHING

(71) Applicant: APPLE INC., Cupertino, CA (US)

(72) Inventors: Ankit BHAMRI, Bad Nauheim (DE); Yuqin CHEN, Beijing (CN); Haitong SUN, Cupertino, CA (US)

(73) Assignee: APPLE INC., Cupertino, CA (US)

(21) Appl. No.: 19/157,265

(22) PCT Filed: Feb. 16, 2023
(86) PCT No.: PCT/CN2023/076431

§ 371 Date: Aug. 15, 2025

(51) Int. Cl. H04W 72/0453; H04B 7/06; H04W 72/51

(52) U.S. Cl. CPC H04W 72/0453; H04B 7/0608; H04W 72/51

(57) ABSTRACT

Aspects are described for a user equipment (UE) comprising one or more transceivers configured to enable wireless communication with a base station, a first antenna and a second antenna coupled to the one or more transceivers, and a processor communicatively coupled to the one or more transceivers. The first and the second antennas are associated with a first and a second frequency bands respectively. The processor is configured to transmit a first signal on the first frequency band and a second signal on the second frequency band to the base station. The processor is further configured to switch, based on a fourth frequency band of second subsequent transmission or a comparison between the first and the second frequency bands, the first antenna to be associated with a third frequency band of first subsequent transmission and transmit the first subsequent signal on the third frequency band to the base station.

### BACKGROUND

### Field The described aspects generally relate to an uplink (UL) transmission switching procedure for new radio (NR) systems.

### SUMMARY

Some aspects of this disclosure relate to systems, apparatuses, and methods for implementing a UL transmission switching procedure for NR systems. For example, the systems, the apparatuses, and the methods are provided for determining and switching one or more antennas to be associated with one or more frequency bands.

Some aspects of this disclosure relate to a user equipment (UE) comprising a transceiver configured to enable wireless communication with a base station, a first antenna and a second antenna coupled to the transceivers, and a processor communicatively coupled to the transceiver. The first antenna is associated with a first frequency band and the second antenna is associated with a second frequency band. The processor is configured to transmit a first signal on the first frequency band to the base station and transmit a second signal on the second frequency band to the base station. The processor is further configured to determine a first subsequent signal transmission on a third frequency band and a second subsequent signal transmission on a fourth frequency band and switch, based on the fourth frequency band or a comparison between the first and the second frequency bands, the first antenna to be associated with the third frequency band. The processor is further configured to transmit the first subsequent signal on the third frequency band to the base station.

Some aspects of this disclosure relate to a method of operating a UE. The method comprises transmitting, using a first antenna of the UE, a first signal on a first frequency band to a base station, wherein the first antenna is associated with the first frequency band and transmitting, using a second antenna of the UE, a second signal on a second frequency band to the base station, wherein the second antenna is associated with the second frequency band. The method further comprises determining a first subsequent signal transmission on a third frequency band and a second subsequent signal transmission on a fourth frequency band and switching, based on the fourth frequency band or a comparison between the first and the second frequency bands, the first antenna to be associated with the third frequency band. The method further comprises transmitting, using the first antenna, the first subsequent signal on the third frequency band to the base station.

Some aspects of this disclosure relate to a non-transitory computer-readable medium (CRM) comprising instructions to, upon execution of the instructions by one or more processors of a UE, cause the UE to perform operations. The operations comprise transmitting, using a first antenna of the UE, a first signal on a first frequency band to a base station, wherein the first antenna is associated with the first frequency band and transmitting, using a second antenna of the UE, a second signal on a second frequency band to the base station, wherein the second antenna is associated with the second frequency band. The operations further comprise determining a first subsequent signal transmission on a third frequency band and a second subsequent signal transmission on a fourth frequency band and switching, based on the fourth frequency band or a comparison between the first and the second frequency bands, the first antenna to be associated with the third frequency band. The operations further comprise transmitting, using the first antenna, the first subsequent signal on the third frequency band to the base station.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing a UL transmission switching procedure for NR systems, according to some aspects of the disclosure.

FIG. 2 illustrates a block diagram of an example system of an electronic device for the UL transmission switching procedure, according to some aspects of the disclosure.

FIG. 3 illustrates the UL transmission switching procedure for a single frequency band switching, according to aspects of the disclosure.

FIG. 4 illustrates the UL transmission switching procedure for a double frequency band switching, according to aspects of the disclosure.

FIG. 5 illustrates an example method of the UL transmission switching procedure, according to aspects of the disclosure.

FIG. 6 is an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to systems, apparatuses, and methods for implementing a UL transmission switching procedure for NR systems. For example, the systems, the apparatuses, and the methods are provided for determining and switching one or more antennas to be associated with one or more frequency bands.

In some aspects, a UE communicates with a base station using a plurality of antennas. For example, the UE can support multiple input and multiple output (MIMO) downlink (DL) transmission. Thus, the UE can use the plurality of antennas to receive signals from the base station. Likewise, the UE can also use the plurality of antennas to transmit signals to the base station in UL transmission in at least two approaches. First, the UE can support dual stream UL transmission. For example, the UE can transmit signals using a first antenna and a second antenna in a first subcarrier and a second subcarrier respectively. The first subcarrier and the second subcarrier can be in a first frequency band, such as a long term evolution (LTE) frequency band or an NR frequency band. In such a case, the UE can aggregate the first subcarrier and the second subcarrier to improve data throughput. Second, the UE can support dual connection (DC) UL transmission. For example, the first subcarrier can be in the first frequency band, such as an LTE frequency band, and the second subcarrier can be in a second frequency band, such as an NR frequency band. In some aspects, a range of the LTE frequency band can be longer than a range of the NR frequency band. Thus, the UE can aggregate the first subcarrier that is in the first frequency band and the second subcarrier that is in the second frequency band to provide reliable communication connections to the base station when the UE is mobile.

In both approaches above, each of the first and the second antennas is associated with a frequency band at a given time. For example, in the first approach above, when the UE performs dual stream UL transmission and the first frequency band is an NR frequency band, the first antenna and the second antenna can be associated with the NR frequency band. For another example, in the second approach above, when the UE performs DC UL transmission, the first antenna can be associated with the LTE frequency band and the second antenna is associated with the NR frequency band. In some aspects, a UE in LTE systems can support two antennas in UL transmissions in two frequency bands. Likewise, a UE in NR systems can support two antennas in UL transmission in three or four frequency bands.

In some aspects, the UE can switch frequency bands that are associated with antennas. For example, the UE can be currently configured to perform dual stream UL transmission in the NR frequency band. Thus, both the first and the second antennas are associated with the NR frequency band. However, the UE can move away from the base station that the UE connects to. In such a case, the UL connection from the UE to the base station can become unstable due to the limited transmission power of the UE in the NR frequency band. To maintain a reliable UL connection, the UE can perform a UL transmission switch to dual stream UL transmission in the LTE frequency band instead. Thus, the UE can switch the first and the second antennas to transmit on subcarriers in the LTE frequency band. Accordingly, the UE switches both the first and the second antennas to be associated with the LTE frequency band. Alternatively, the UE can perform a UL transmission switch to perform DC UL transmission instead. Thus, the UE can switch one of the first and second antennas to transmit on a subcarrier in the LTE frequency band. For example, the UE can switch the first antenna to be associated with the LTE frequency band, while the second antenna remains associated with the NR frequency band, and thus perform DC UL transmission. However, it can be ambiguous regarding whether to switch to the dual stream UL transmission in the LTE frequency band or to the DC UL transmission.

In some aspects, the base station can assist in resolving the ambiguity. For example, the base station can transmit a configuration message to the UE. The configuration message can indicate whether to switch two antennas from their current assignment or switch one antenna from its current assignment. If the configuration message indicates switching two antennas, the UE can perform the dual stream UL transmission on the LTE frequency band. Likewise, if the configuration message indicates switching one antenna, the UE can perform the DC UL transmission. In some aspects, after determining to perform the DC UL transmission, the UE still needs to determine whether to switch the first antenna or the second antenna. The UE can determine based on further configuration messages received from the base station or other factors, such as characteristics of the NR frequency band and the LTE frequency band.

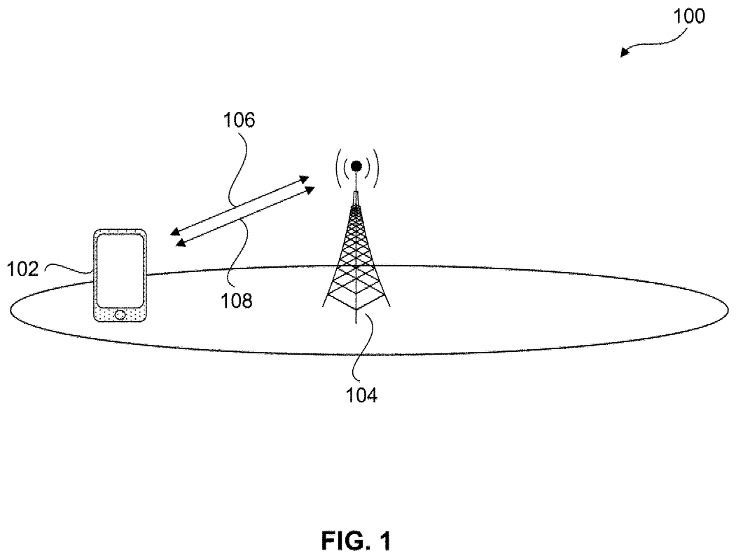

FIG. 1 illustrates an example system 100 implementing a UL transmission switching procedure for NR systems, according to some aspects of the disclosure. The example system 100 is provided for the purpose of illustration only and does not limit the disclosed aspects. The example system 100 may include, but is not limited to, a UE 102 and a base station 104. The UE 102 may be implemented as electronic devices configured to operate based on a wide variety of wireless communication techniques. These techniques may include, but are not limited to, techniques based on 3rd Generation Partnership Project (3GPP) standards. For example, the UE 102 can be configured to operate using one or more 3GPP releases, such as Release 15 (Rel-15), Release 16 (Rel-16), Release 17 (Rel-17), Release 18 (Rel-18), or other 3GPP releases. The UE 102 may include, but is not limited to, wireless communication devices, smartphones, laptops, desktops, tablets, personal assistants, monitors, televisions, wearable devices, Internet of Things (IoT) devices, vehicle communication devices, and the like. The base station 104 may include one or more nodes configured to operate based on a wide variety of wireless communication techniques such as, but not limited to, techniques based on the 3GPP standards. For example, the base station 104 may include nodes configured to operate using Rel-15, Rel-16, Rel-17, Rel-18, or other 3GPP releases. The base station 104 may include, but not limited to, NodeBs, eNodeBs, gNBs, new radio base stations (NR BSs), access points (APs), remote radio heads, relay stations, and others.

In some aspects, the UE 102 connects with the base station 104 via communication links 106 and 108. The communication links 106 and 108 can each include uplink (UL) connections and downlink (DL) connections. In some aspects, the UE 102 can communicate with the base station 104 using a plurality of antennas. For example, the UE 102 can receive signals from the base station 104 using four antennas via MIMO DL transmission. For another example, the UE 102 can transmit signals to the base station 104 using two antennas, such as a first antenna and a second antenna, via UL transmission. In some aspects, the communication link 106 can be in a first frequency band, such as an NR frequency band, and the communication link 108 can be in a second frequency band, such as an LTE frequency band. The UE 102 can perform UL transmissions via the communication link 106 using both the first antenna and the second antenna. In such a case, the UE 102 can perform dual stream UL transmission on the first frequency band and thus the first and the second antennas are associated with respective first and second subcarriers that are in the first frequency band. In some aspects, the UE can perform DC UL transmission via the communication links 106 and 108. For example, the UE 102 can transmit on the first subcarrier in the first frequency band using the first antenna and transmit on a third subcarrier in the second frequency band using the second antenna.

In some aspects, the UE 102 can currently perform dual stream UL transmission on the first and second subcarriers, and then determine that the next transmission is on the third subcarrier in the second frequency band. The UE 102 can determine whether to switch both the first and the second antennas to the third subcarrier or switch one of the first and the second antennas to the third subcarrier. In some aspects, the UE 102 can determine based on a configuration message received from the base station 104. For example, the base station 104 can transmit the configuration message to the UE 102 via radio resource control (RRC) messaging. The configuration message can include a control parameter that can be “oneT,” “twoT,” or other values. If the control message indicates “twoT,” the UE 102 can switch both the first and the second antennas to the third subcarrier. Otherwise, the UE 102 can switch one of the first and the second antennas to the third subcarrier (or to be associated with the third subcarrier). In some aspects, the base station 104 can transmit a second configuration message, such as a further RRC parameter, to configure the UE 102 to switch the first antenna or the second antenna to the third subcarrier.

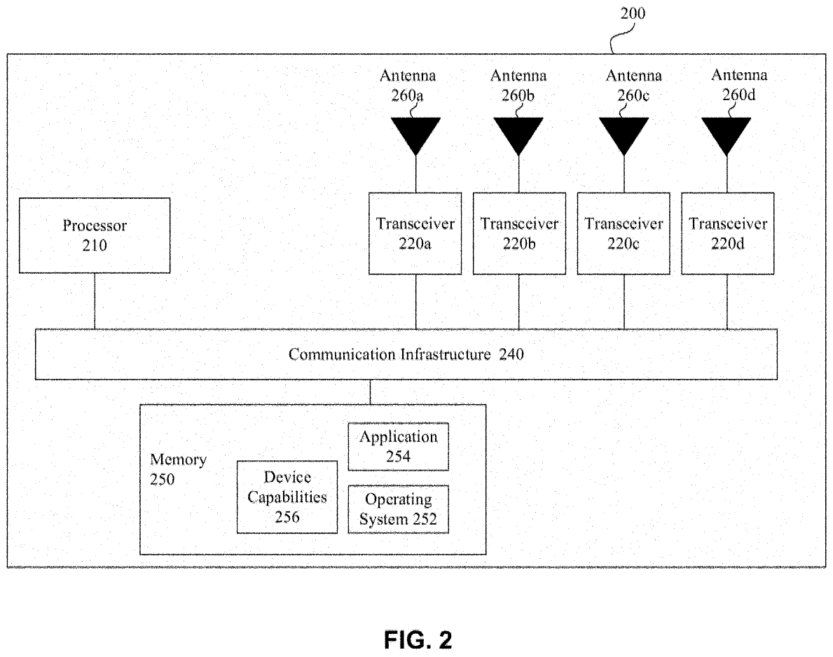

FIG. 2 illustrates a block diagram of an example system 200 of an electronic device implementing the UL transmission switching procedure, according to some aspects of the disclosure. The system 200 may be any of the electronic devices (e.g., the UE 102 and the base station 104) of the system 100. The system 200 includes a processor 210, transceivers 220a, 220b, 220c, and 220d, a communication infrastructure 240, a memory 250, an operating system 252, an application 254, and antennas 260a, 260b, 260c and 206d. Illustrated systems are provided as exemplary parts of system 200, and system 200 may include other circuit(s) and subsystem(s). Also, although the systems of system 200 are illustrated as separate components, the aspects of this disclosure may include any combination of these, e.g., less, or more components. In some aspects, it is noted that a single transceiver 220 (or less than 4) can be tuned and/or time-shared to support the antennas 260a-d, as will be understood by those skilled in the arts.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the transceivers 220a, 220b, 220c, and 220d. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by wireless system 200 and/or a user of wireless system 200. The applications in the application 254 may include applications such as, but not limited to radio streaming, video streaming, remote control, and/or other user applications.

The system 200 may also include the communication infrastructure 240. The communication infrastructure 240 provides communication between, for example, the processor 210, the transceivers 220a, 220b, 220c, and 220d, and the memory 250. In some implementations, the communication infrastructure 240 may be a bus.

The processor 210, alone, or together with instructions stored in the memory 250 performs operations enabling system 200 of the system 100 to implement mechanisms for the UL transmission switching procedure, as described herein. Alternatively, or additionally, the processor 210 can be “hard coded” to implement the UL transmission switching procedure, as described herein.

The transceivers 220a, 220b, 220c, and 220d transmit and receive communications signals support the UL transmission switching procedure. Additionally, the transceivers 220a, 220b, 220c, and 220d transmit and receive communications signals that support mechanisms for measuring communication link(s), generating and transmitting system information, and receiving the system information. According to some aspects, the one or more transceivers 220a, 220b, 220c, and 220d may be coupled to the antennas 260a, 260b, 260c, and 206d to wirelessly transmit and receive the communication signals. The antennas 260a, 260b, 260c, and 206d may be the same or different types. In some aspects, the antennas 260a, 260b, 260c, and 206d are located in different positions of the system 200, such as four corners of the system 200. In some aspects, the antennas 260a, 260b, 260c, and 206d can be associated with their respective subcarriers. For example, the antenna 260a can be coupled to a corresponding transceiver, such as the transceiver 220a, and can form a first transmission chain with the corresponding transceiver. The first transmission chain can include the antenna 260a, one or more low-noise amplifiers (LNAs), one or more mixers, one or more filters, one or more oscillators, one or more modulators, and other components. When the antenna 260a is associated with a first subcarrier, the first transmission chain is associated with the first subcarrier. For example, the one or more filters can be configured to remove signals in subcarriers other than the first subcarrier. For another example, the one or more oscillators can be configured to generate carrier signals corresponding the first subcarrier. When the antenna 260a is switched to be associated with a second subcarrier, the first transmission chain is switched to the second subcarrier. For example, the one or more filters can be configured to remove signals in subcarriers other than the second subcarrier and the one or more oscillators can be configured to generate carrier signals corresponding to the second subcarrier. In some aspects, the first subcarrier is in a first frequency band, such as an LTE frequency band, and the second subcarrier is in a second frequency band, such as an NR frequency band.

In some aspects, a transmission chain, such as the first transmission chain, takes time to switch from a subcarrier in one frequency band, such as the first subcarrier of the first frequency band, to another subcarrier in a different frequency band, such as the second subcarrier of the second frequency band. For example, one or more filters of the transmission chain and one or more oscillators of the transmission chain need to be adjusted according to the second subcarrier. Thus, a time interval between the end of a UL transmission on the first frequency band and the beginning of a subsequent UL transmission on the second frequency band is referred to as a switching gap or a switching period of the first transmission chain to switch from the first frequency band to the second frequency band. Because the first transmission chain corresponds to the antenna 260a, the switching gap or the switching period of the first transmission chain is also the switching gap or the switching period of the antenna 260a. In some aspects, a switching gap depends on frequency bands that the switch is performed between. For example, for the first transmission chain and the antenna 260a, a switching gap of switching from the first frequency band to the second frequency band is different from a switching gap of switching from the first frequency band to a third frequency band.

In some aspects, the transceivers 220a, 220b, 220c, and 220d allow system 200 to communicate with other devices that may be wired and/or wireless. In some examples, the transceivers 220a, 220b, 220c, and 220d may further include processors, controllers, radios, sockets, plugs, buffers, and like circuits/devices used for connecting to and communication on networks. According to some examples, the transceivers 220a, 220b, 220c, and 220d include one or more circuits to connect to and communicate on wired and/or wireless networks.

According to some aspects of this disclosure, the transceivers 220a, 220b, 220c, and 220d may include a cellular subsystem, a WLAN subsystem, and/or a Bluetooth™M subsystem, each including its own radio transceiver and protocol(s) as will be understood by those skilled in the arts based on the discussion provided herein. In some implementations, the transceivers 220a, 220b, 220c, and 220d may include more or fewer systems for communicating with other devices.

In some examples, the transceivers 220a, 220b, 220c, and 220d may include one or more circuits (including a WLAN transceiver) to enable connection(s) and communication over WLAN networks such as, but not limited to, networks based on standards described in IEEE 802.11.

Additionally, or alternatively, the transceivers 220a, 220b, 220c, and 220d may include one or more circuits (including a Bluetooth transceiver) to enable connection(s) and communication based on, for example, Bluetooth protocol, the Bluetooth™ Low Energy protocol, or the Bluetooth™ Low Energy Long Range protocol. For example, the transceivers 220a, 220b, 220c, and 220d may include a Bluetooth M transceiver.

Additionally, the transceivers 220a, 220b, 220c, and 220d may include one or more circuits (including a cellular transceiver) for connecting to and communicating on cellular networks. The cellular networks may include, but are not limited to, 3G/4G/5G networks such as Universal Mobile Telecommunications System (UMTS), Long-Term Evolution (LTE), and the like. For example, the transceivers 220a, 220b, 220c, and 220d may be configured to operate according to one or more of Rel-15, Rel-16, Rel-17, Rel-18, or other releases of 3GPP standard.

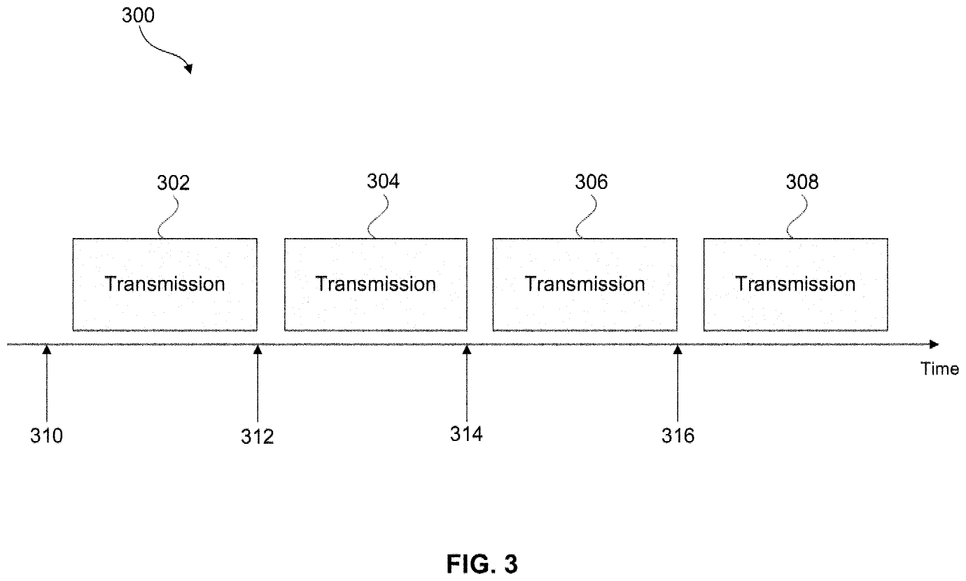

As discussed in more detail below with respect to FIGS. 3-6, processor 210 may implement different mechanisms for the UL transmission switching procedure as discussed with respect to the system 100 of FIG. 1.

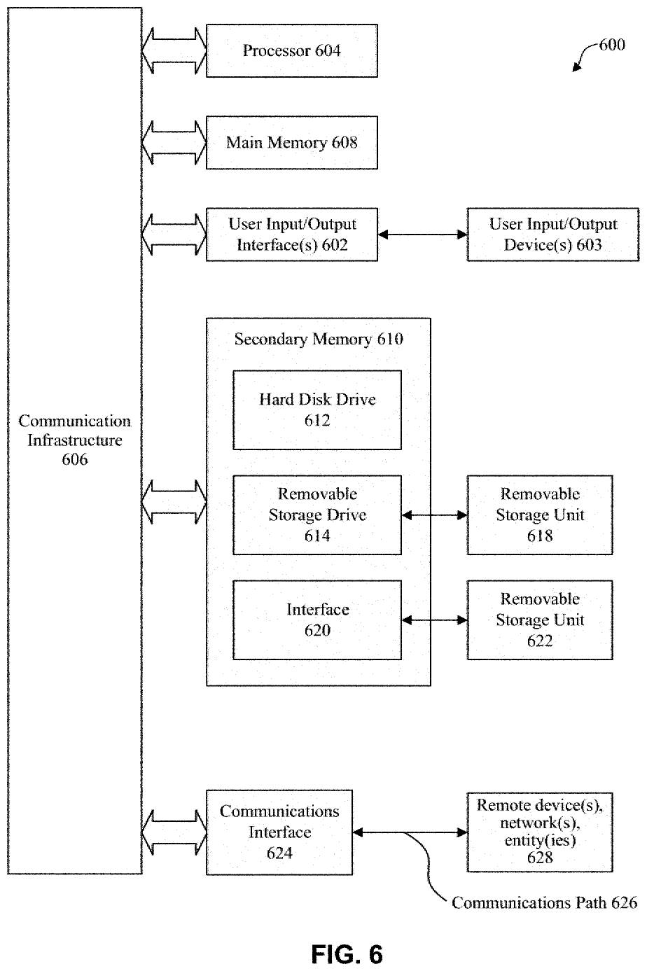

FIG. 3 illustrates an example 300 of the UL transmission switching procedure for a single frequency band switching, according to aspects of the disclosure. The example 300 is provided for the purpose of illustration only and does not limit the disclosed aspects. As a convenience and not a limitation, FIG. 3 may be described with regard to elements of FIGS. 1, 2, and 6. The example 300 may represent the operation of electronic devices (for example, the UE 102 and the base station 104 of FIG. 1) implementing the reference signal configuration procedure. The example 300 may also be performed by the electronic device 200 of FIG. 2, controlled or implemented by processor 210, and/or computer system 600 of FIG. 6. But the example 300 is not limited to the specific aspects depicted in those figures and other systems may be used to perform the method, as will be understood by those skilled in the art. It is to be appreciated that not all operations may be needed, and the operations may not be performed in the same order as shown in FIG. 3.

In some aspects, the example 300 includes UL transmission 302, UL transmission 304, UL transmission 306, and UL transmission 308 that are scheduled to be performed in an order shown here by a UE, such as the UE 102 of FIG. 1. In some aspects, each transmission can be associated with a frequency band. For example, the UL transmission 302 can be scheduled to be performed on a frequency band A; the UL transmission 304 can be scheduled to be performed on a frequency band B; the UL transmission 306 can be scheduled to be performed on a frequency band C; and the UL transmission 308 can be scheduled to be performed on the frequency band A.

In some aspects, the UE is configured with a first antenna and a second antenna to perform UL transmission, such as the UL transmission 302, the UL transmission 304, the UL transmission 306, and the UL transmission 308. At a time point 310, which is before the transmission 302, the first antenna can be associated with the frequency band A and the second antenna can be associated with the frequency band B. In such a case, the UE can perform the UL transmission 302 using the first antenna on the frequency band A and finishes the UL transmission 302 at a time point 312. After that, the UE can perform the UL transmission 304 using the second antenna on the frequency band B. Because the first antenna and the second antenna are already associated with the frequency bands A and B, no switching is needed at the time points 310 or 312. However, because the UL transmission 306 is associated with the frequency band C, at least one of the first antenna and the second antenna is required to switch to the frequency band C at a time point 314.

In some aspects, the UE can switch using one of two approaches. First, the UE can switch both the first and the second antennas to the frequency band C and the UL transmission 306 can be performed using both or one of the first antenna and the second antenna. Second, the UE can switch only one of the first and the second antennas to the frequency band C and the UL transmission 306 can be performed using the switched antenna. Herein “switching an antenna(s)” to a different frequency band can include adjusting the corresponding transceiver 220 as described above with respect to FIG. 2. This can include adjusting the corresponding amplifier(s), oscillator(s), filter(s), and other circuits of the antenna as necessary to support communication using the different frequency. As described above, the antenna and its corresponding transceiver for a transmission chain, which is adjusted in tandem to effect the switch.

The UE can determine whether to take the first approach or the second approach based a configuration message from a base station, such as the base station 104 of FIG. 1. For example, the base station can transmit the configuration message to the UE via RRC signaling. The configuration message can include a control parameter that can be “oneT,” “twoT,” or other values. If the control parameter indicates “twoT,” the UE can take the first approach and switch both the first and the second antennas to the frequency band C. Otherwise, and if the control parameter indicates “oneT,” the UE can take the second approach and switch one of the first and the second antennas to the frequency band C.

In some aspects, the UE may transmit a capability report to the base station, where the capability report indicates whether the UE can support dual stream UL transmission on one or more frequency bands. For example, the capability report can indicate that the UE does not support dual stream UL transmission on the frequency band C. In such a case, the UE is not able to or is configured not to perform UL transmission on the frequency band C using both the first antenna and the second antenna simultaneously. In some aspects, the control parameter of the configuration message may still indicate “twoT” while the capability report indicates that dual stream UL transmission is not supported on the frequency band C. In such a case, the UE can ignore the “twoT” indication and take the second approach to switch one of the first and the second antennas to the frequency band C. In some aspects, the base station, receiving the capability report, can also assume that the UE takes the second approach instead of the first approach as indicated by the “twoT” indication. In other words, when the configuration message conflicts with the capability report, both the UE and the base station follow the capability report.

In some aspects, if the UE determines to take the second approach and switch one of the first and the second antennas to the frequency band C, the UE also needs to determine whether to switch the first antenna or the second antenna. In some aspects, the UE can determine based on associated bands. For example, the configuration message may further include band pair parameters that indicate one or more pairs of frequency bands that can be configured together. For example, the one or more pairs of frequency bands can include (B for A), (A for B), (A for C), and (C for D). In such a case, frequency bands that the first and the second antennas are associated with are required to be one of the one or more pairs. For example, if the first antenna is associated with the frequency band B and the second antenna is associated with the frequency band A, the frequency bands of the first and the second antennas match the pair (B for A). For another example, if the first antenna is associated the frequency band A and the second antenna is associated with the frequency band D, the frequency bands of the first and the second antennas are (A for D), which do not match any of the one or more pairs listed above. Here, because the UL transmission 306 is associated with the frequency band C, the UE can determine to switch the second antenna to the frequency band C. Thus, after switching, the frequency bands of the first and the second antennas are A and C, which match the pair (A for C). Otherwise, if the UE switches the first antenna to the frequency band C, the frequency bands of the first and the second antennas after switching after B and C, which do not match any of the one or more pairs of frequency bands. In some aspects, if the UL transmission 306 is on the frequency band D, instead of the frequency band C, the UE is required to switch both the first and the second antennas. Specifically, if the UE only switches the first antenna, the frequency bands after switching are D and B, which do not match any of the one or more pairs of frequency bands. If the UE only switches the second antenna, the frequency band after switching are A and D, which also do not match any of the one or more pairs of frequency bands. Thus, the UE is forced to switch both the first and the second antennas to a combination of frequency bands C and D. For example, the UE may be forced to switch the first antenna to the frequency band C and switch the second antenna to the frequency band D. However, the UE may not need to transmit in the frequency band C at all or the UE may switch the first antenna to another frequency band before UL transmission on the frequency band C is scheduled. In such a case, switching the first antenna does not benefit any additional UL transmission, but is forced by the associated bands.

In some aspects, when determining whether to switch the first antenna or the second antenna, the UE can assume to maintain one frequency band to be associated with at least one antenna. For example, the UE can determine that at least one antenna needs to be associated with the frequency band A. In such a case, at the time point 314, the UE can switch the second antenna to the frequency band C, so that the first antenna is still associated with the frequency band A. In some aspects, the UE can also report the frequency band A to the base station indicating at least one antenna of the first and the second antenna would stay on the frequency band A at any given time. In such a case, the base station can predict how the UE switches antennas.

In some aspects, the UE can determine which antenna to switch based on two subsequent UL transmission. For example, at the time point 314, the UE can determine that two subsequent UL transmissions include the UL transmission 306 in the frequency band C and the UL transmission 308 in the frequency band A. The UE can consider a potential subsequent switch at a time point 316. For example, if the UE switches the first antenna to the frequency band C at the time point 314, the first and the second antennas are respectively associated with the frequency bands C and B at the time point 316. Thus, the UE needs to perform UL transmission switch again to transmit on the frequency band A in the UL transmission 308. However, if the UE switches the second antenna to the frequency band C at the time point 314, the first and the second antennas are associated with the frequency bands A and C at the time point 316. In such a case, no UL transmission switching is needed to perform the UL transmission 308 on the frequency band A. Thus, to avoid the potential subsequent switch at the time point 316, the UE can choose to switch the second antenna to the frequency band C at the time point 314. In some aspects, to perform switching this way, the UE is required to determine the frequency bands of the UL transmission 306 and 308 before switching the first antenna or the second antenna.

In some aspects, the UE can determine which antenna to switch based on a comparison between frequency bands that are associated with the first and the second antennas. For example, at the time point 314, the UE can determine that the UL transmission 306 is on the frequency band C. The UE can then determine a first switching gap of the first antenna from the frequency band A to the frequency band C and a second switching gap of the second antenna from the frequency band B to the frequency band C. The UE can determine to switch the first antenna if the first switching gap is smaller than the second switching gap or switch the second antenna if otherwise. If the first switching gap is the same as the second switching gap, other comparisons need to be performed to determine which antenna to switch, as discussed in more detail below.

In some aspects, the UE can compare duplex-types of the frequency band A and the frequency band B. For example, the UE can determine that the frequency band A is a frequency division duplexing (FDD) band, such as a band n70 and the frequency band B is a time division duplexing (TDD) band, such as a band n78. The UE may determine to switch a TDD band and thus switch the second antenna. Alternatively, the UE may determine to switch an FDD band and thus switch the first antenna.

In some aspects, the UE can compare band numbers of the frequency band A and the frequency band B. For example, the UE can determine that the frequency band A is a band n34 and the frequency band B is a band n78. The UE may determine to switch a frequency band with a lower band number and thus switch the first antenna. Alternatively, the UE may determine to switch a frequency band with a higher band number and thus switch the second antenna.

In some aspects, the UE can compare band types of the frequency band A and the frequency band B. For example, the UE can determine that the frequency band A is a supplementary uplink (SUL) band and the frequency band B is a normal uplink (NUL) band. In some aspects, the UE can use SULs to the extend coverage area of the base station. For example, when the UE moves beyond coverage areas of NULs, the UE can switch to SULs for UL transmission. The UE may determine to switch an SUL frequency band and thus switch the first antenna. Alternatively, the UE may determine to switch a NUL frequency band and thus switch the second antenna.

In some aspects, the UE can determine to use one or more approaches discussed above to select an antenna to switch based on one or more configuration messages received from the base station or locally at the UE.

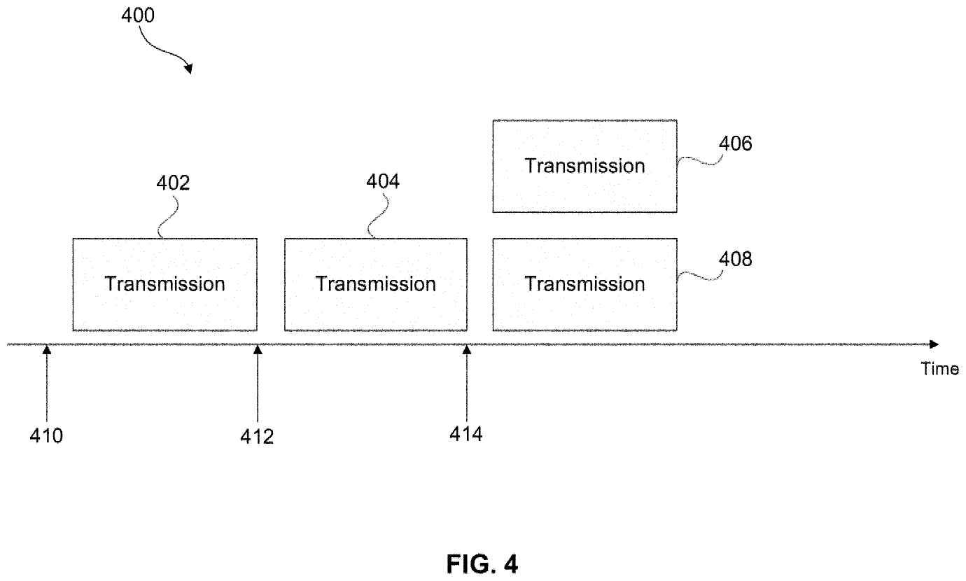

FIG. 4 illustrates the UL transmission switching procedure for a double frequency band switching, according to aspects of the disclosure. The example 400 is provided for the purpose of illustration only and does not limit the disclosed aspects. As a convenience and not a limitation, FIG. 4 may be described with regard to elements of FIGS. 1, 2, and 6. The example 400 may represent the operation of electronic devices (for example, the UE 102 and the base station 104 of FIG. 1) implementing the reference signal configuration procedure. The example 400 may also be performed by the electronic device 200 of FIG. 2, controlled or implemented by processor 210, and/or computer system 600 of FIG. 6. But the example 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

In some aspects, the example 400 includes UL transmission 402, UL transmission 404, UL transmission 406, and UL transmission 408 that are scheduled to be performed in an order shown here by a UE, such as the UE 102 of FIG. 1. In some aspects, each transmission can be associated with a frequency band. For example, the UL transmission 402 can be scheduled to be performed on a frequency band A; the UL transmission 404 can be scheduled to be performed on a frequency band B; the UL transmission 406 can be scheduled to be performed on a frequency band C; and the UL transmission 408 can be scheduled to be performed on the frequency band D.

In some aspects, the UE is configured with a first antenna and a second antenna to perform UL transmission, such as the UL transmission 402, the UL transmission 404, the UL transmission 406, and the UL transmission 408. At a time point 410, which is before the transmission 402, the first antenna can be associated with the frequency band A and the second antenna can be associated with the frequency band B. In such a case, the UE can perform the UL transmission 402 using the first antenna on the frequency band A and finishes the UL transmission 402 at a time point 412. After that, the UE can perform the UL transmission 404 using the second antenna on the frequency band B. Because the first antenna and the second antenna are already associated with the frequency bands A and B, no switching is needed. However, because the UL transmission 406 and the UL transmission 408 are associated with the frequency band C and the frequency D respectively, both the first antenna and the second antenna are required to switch at a time point 414. Specifically, the UE needs to determine whether switch the first antenna and the second antenna to the frequency bands C and D respectively or the frequency band D and C respectively.

In some aspects, the UE can determine based on switching gaps. For example, the UE can determine a first switching gap to switch the first antenna from the frequency band A to the frequency band C and a second switching gap to switch the second antenna from the frequency band B to the frequency band D. The UE can further determine a third switching gap to switch the first antenna from the frequency band A to the frequency band D and a fourth switching gap to switch the second antenna from the frequency band B to the frequency band C.

In some aspects, the UE can determine how to switch antennas in four approaches. First, the UE can determine to switch with minimized maximum switching gaps. For example, if the larger of the first switching gap and the second switching gap is smaller than the larger of the third switching gap and the fourth switching gap, the UE can determine to switch the first antenna to the frequency band C and switch the second antenna to the frequency D. Otherwise, the UE can determine to switch the first antenna to the frequency D and switch the second antenna to the frequency C. Second, the UE can determine to switch with maximized maximum switching gaps. For example, if the larger of the first switching gap and the second switching gap is larger than the larger of the third switching gap and the fourth switching gap, the UE can determine to switch the first antenna to the frequency band C and switch the second antenna to the frequency D. Otherwise, the UE can determine to switch the first antenna to the frequency D and switch the second antenna to the frequency C. Third, the UE can determine to switch with minimized sum switching gap. For example, if a sum of the first switching gap and the second switching gap is smaller than a sum of the third switching gap and the fourth switching gap, the UE can determine to switch the first antenna to the frequency band C and switch the second antenna to the frequency D. Otherwise, the UE can determine to switch the first antenna to the frequency D and switch the second antenna to the frequency C. Fourth, the UE can determine to switch with maximized sum switching gap. For example, if a sum of the first switching gap and the second switching gap is larger than a sum of the third switching gap and the fourth switching gap, the UE can determine to switch the first antenna to the frequency band C and switch the second antenna to the frequency D. Otherwise, the UE can determine to switch the first antenna to the frequency D and switch the second antenna to the frequency C.

In some aspects, the UE can determine which approach to use to switch antennas based on one or more configuration messages received from the base station or locally at the UE.

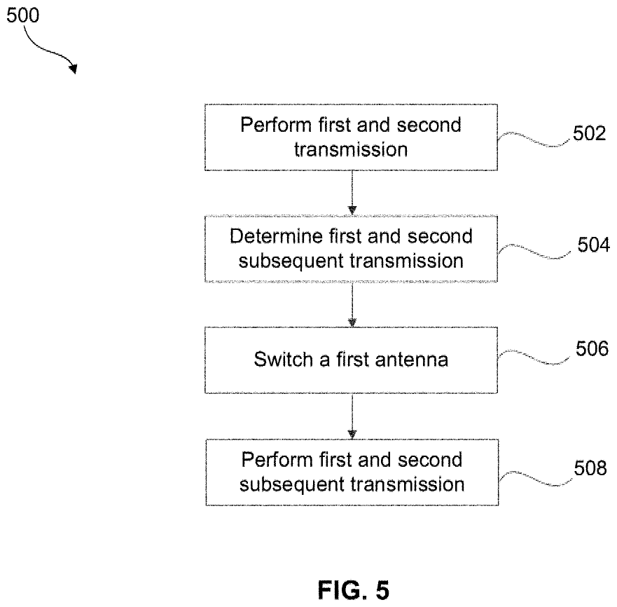

FIG. 5 illustrates an example method 500 of the UL transmission switching procedure, according to aspects of the disclosure. The example method 500 is provided for the purpose of illustration only and does not limit the disclosed aspects. As a convenience and not a limitation, FIG. 5 may be described with regard to elements of FIGS. 1, 2, and 6. The example method 500 may represent the operation of electronic devices (for example, the UE 102 and the base station 104 of FIG. 1) implementing the UL transmission switching procedure. The example method 500 may also be performed by the electronic device 200 of FIG. 2, controlled or implemented by processor 210, and/or computer system 600 of FIG. 6. But the example method 500 is not limited to the specific aspects depicted in those figures and other systems may be used to perform the method, as will be understood by those skilled in the art. It is to be appreciated that not all operations may be needed, and the operations may not be performed in the same order as shown in FIG. 5.

At 502, a UE, such as the UE 102, performs first UL transmission using a first antenna of the UE on a first frequency band and second UL transmission using a second antenna of the UE on a second frequency band. In some aspects, the first antenna is associated with the first frequency band and the second antenna is associated with the second frequency band.

At 504, the UE determines a first subsequent UL transmission on a third frequency band and a second subsequent UL transmission on a fourth frequency band. In some aspects, the first and the second subsequent UL transmission can be at different times, such as the UL transmission 306 and the UL transmission 308 of FIG. 3. In other aspects, the first and the second subsequent UL transmission can be at the same time, such as the UL transmission 406 and the UL transmission 408 of FIG. 4.

At 506, the UE switches the first antenna to be associated with the third frequency band. In some aspects, the UE can determine to switch one of the first and the second antennas based on a configuration message received from a base station, such as the base station 104 of FIG. 1. As discussed above, the configuration message can indicate whether to switch both the first and the second antennas or to switch one of the first and the second antennas.

In some aspects, the UE can determine to switch the first antenna based on the fourth frequency band. For example, as discussed in FIG. 3, the UE may determine that the fourth frequency band of the second subsequent UL transmission is the same as the second frequency band of the second antenna. Thus, switching the first antenna can avoid additional switches before performing the second subsequent UL transmission.

In some aspects, the UE can also determine to switch the first antenna based on a comparison between the first and the second frequency bands as discussed in FIG. 3. For example, the UE can compare a switching gap of switching from the first frequency band and a switching gap of switching from the second frequency band. For another example, the UE can compare duplex-types, band numbers, and/or band types of the first and the second frequency bands.

At 508, the UE performs the first subsequent UL transmission and the second subsequent UL transmission. In some aspects, the UE can perform the first subsequent UL transmission on the third frequency band using the first antenna. The UE can also perform the second UL transmission the fourth frequency band using the second antenna.

Various aspects can be implemented, for example, using one or more computer systems, such as computer system 600 shown in FIG. 6. Computer system 600 can be any well-known computer capable of performing the functions described herein such as devices 102, 104, and 106 of FIG. 1, or 200 of FIG. 2. Computer system 600 includes one or more processors (also called central processing units, or CPUs), such as a processor 604. Processor 604 is connected to a communication infrastructure 606 (e.g., a bus.) Computer system 600 also includes user input/output device(s) 603, such as monitors, keyboards, pointing devices, etc., that communicate with communication infrastructure 606 through user input/output interface(s) 602. Computer system 600 also includes a main or primary memory 608, such as random access memory (RAM). Main memory 608 may include one or more levels of cache. Main memory 608 has stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to some aspects, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

The operations in the preceding aspects may be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 600, main memory 608, secondary memory 610 and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 6. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE) comprising:
one or more transceivers configured to enable wireless communications with a base station;
a first antenna and a second antenna coupled to the one or more transceivers, wherein the first antenna is associated with a first frequency band and the second antenna is associated with a second frequency band; and
a processor, communicatively coupled to the one or more transceivers, and configured to:
transmit, using the first antenna, a first signal on the first frequency band to the base station;
transmit, using the second antenna, a second signal on the second frequency band to the base station;
determine a first subsequent signal transmission on a third frequency band and a second subsequent signal transmission on a fourth frequency band;
switch, based on the fourth frequency band or a comparison between the first and the second frequency bands, the first antenna to be associated with the third frequency band; and
transmit, using the first antenna, the first subsequent signal on the third frequency band to the base station.

2. The UE of claim 1, wherein the processor is further configured to:
receive, using the one or more transceivers, a configuration message from the base station, wherein the configuration message indicates to switch both of the first antenna and the second antenna or one of the first antenna and the second antenna; and
switch the first antenna to be associated with the third frequency band based further on the configuration message.

3. The UE of claim 2, wherein the processor is further configured to:
transmit, using the one or more transceivers, a capability report to the base station, wherein the capability report indicates that dual-antenna transmission is not supported on the third frequency band;
determine that the configuration message indicates to switch both of the first antenna and the second antenna; and
switch only the first antenna to be associated with the third frequency band based on the capability report.

4. The UE of claim 1, wherein to perform the comparison between the first and the second frequency bands, the processor is further configured to:
compare a first band number of the first frequency band and a second band number of the second frequency band;
compare a first band type of the first frequency band and a second band type of the second frequency band; or
compare a first duplex-type of the first frequency band and a second duplex-type of the second frequency band.

5. The UE of claim 4, wherein to compare the first band number of the first frequency band and the second band number of the second frequency band, the processor is further configured to:
determine whether the first band number is higher than the second band number.

6. The UE of claim 4, wherein to compare the first band type of the first frequency band and the second band type of the second frequency band, the processor is further configured to:
determine whether the first band type is a supplementary uplink type and whether the second band type is a supplementary uplink type.

7. The UE of claim 4, wherein to compare the first duplex-type of the first frequency band and the second duplex-type of the second frequency band, the processor is further configured to:
determine whether the first duplex-type is a frequency division duplexing (FDD) type or a time division duplexing (TDD) type.

8. The UE of claim 1, wherein to switch the first antenna to be associated with the third frequency band, the processor is further configured to:
determine that the fourth frequency band is the same as the second frequency band,
wherein the second subsequent signal transmission is scheduled after the first subsequent signal transmission.

9. The UE of claim 1,
wherein the first subsequent signal transmission is scheduled at a same time as the second subsequent signal transmission, and
wherein the processor is further configured to:
determine a first switching gap to switch from the first frequency band to the third frequency band or from the first frequency band to the fourth frequency band;
determine a second switching gap to switch from the second frequency band to the third frequency band or from the second frequency band to the fourth frequency band; and
switch, based on the first switching gap and the second switching gap, the first antenna to be associated with the third frequency band and the second antenna to be associated with the fourth frequency band.

10. A method of operating a user equipment (UE) comprising:
transmitting, using a first antenna of the UE, a first signal on a first frequency band to a base station, wherein the first antenna is associated with the first frequency band;
transmitting, using a second antenna of the UE, a second signal on a second frequency band to the base station, wherein the second antenna is associated with the second frequency band;
determining a first subsequent signal transmission on a third frequency band and a second subsequent signal transmission on a fourth frequency band;
switching, based on the fourth frequency band or a comparison between the first and the second frequency bands, the first antenna to be associated with the third frequency band; and
transmitting, using the first antenna, the first subsequent signal on the third frequency band to the base station.

11. The method of claim 10, further comprising:
receiving a configuration message from the base station, wherein the configuration message indicates to switch both of the first antenna and the second antenna or one of the first antenna and the second antenna; and
switching the first antenna to be associated with the third frequency band further based on the configuration message.

12. The method of claim 11, further comprising:
transmitting a capability report to the base station, wherein the capability report indicates that dual-antenna transmission is not supported on the third frequency band;
determining that the configuration message indicates to switch both of the first antenna and the second antenna; and
switching only the first antenna to be associated with the third frequency band based on the capability report.

13. The method of claim 10, wherein the comparison between the first and the second frequency bands further comprises:
comparing a first band number of the first frequency band and a second band number of the second frequency band;
comparing a first band type of the first frequency band and a second band type of the second frequency band; or
comparing a first duplex-type of the first frequency band and a second duplex-type of the second frequency band.

14. The method of claim 13, wherein comparing the first band number of the first frequency band and the second band number of the second frequency band further comprising determining whether the first band number is higher than the second band number.

15. The UE of claim 13, wherein comparing the first band type of the first frequency band and the second band type of the second frequency band further comprising determining whether the first band type is a supplementary uplink type and whether the second band type is a supplementary uplink type.

16. The UE of claim 13, wherein comparing the first duplex-type of the first frequency band and the second duplex-type of the second frequency band further comprising determining whether the first duplex-type is a frequency division duplexing (FDD) type or a time division duplexing (TDD) type.

17. The UE of claim 10, wherein switching the first antenna to be associated with the third frequency band further comprises:
determining that the fourth frequency band is the same as the second frequency band,
wherein the second subsequent signal transmission is scheduled after the first subsequent signal transmission.

18. The UE of claim 10,
wherein the first subsequent signal transmission is scheduled at a same time as the second subsequent signal transmission, and
wherein the method further comprises:
determining a first switching gap to switch from the first frequency band to the third frequency band or from the first frequency band to the fourth frequency band;
determining a second switching gap to switch from the second frequency band to the third frequency band or from the second frequency band to the fourth frequency band; and
switching, based on the first switching gap and the second switching gap, the first antenna to be associated with the third frequency band and the second antenna to be associated with the fourth frequency band.

19. A non-transitory computer-readable medium (CRM) comprising instructions to, upon execution of the instructions by one or more processors of a user equipment (UE), cause the UE to perform operations, the operations comprising:
transmitting, using a first antenna of the UE, a first signal on a first frequency band to a base station, wherein the first antenna is associated with the first frequency band;
transmitting, using a second antenna of the UE, a second signal on a second frequency band to the base station, wherein the second antenna is associated with the second frequency band;
determining a first subsequent signal transmission on a third frequency band and a second subsequent signal transmission on a fourth frequency band;
switching, based on the fourth frequency band or a comparison between the first and the second frequency bands, the first antenna to be associated with the third frequency band; and
transmitting, using the first antenna, the first subsequent signal on the third frequency band to the base station.

20. The non-transitory CRM of claim 19, wherein the comparison between the first and the second frequency bands further comprises:
comparing a first band number of the first frequency band and a second band number of the second frequency band;
comparing a first band type of the first frequency band and a second band type of the second frequency band; or
comparing a first duplex-type of the first frequency band and a second duplex-type of the second frequency band.
